(19) United States
(12) Patent Application Publication
(10) Pub. No.: US 2005/0116450 A1
(43) Pub. Date: Jun. 2, 2005

(54) Airbag apparatus

(75) Inventor: Atsushi Noguchi, Moriyama-shi (JP)

Correspondence Address: FOLEY AND LARDNER;SUITE 500, 3000 K STREET NW, WASHINGTON, DC, 20007, US

(73) Assignee: TAKATA CORPORATION

(21) Appl. No.: 10/986,213

(22) Filed: Nov. 12, 2004

(30) Foreign Application Priority Data
Dec. 2, 2003 (JP) 2003-403197

(51) Int. Cl. B60R 21/22

(52) U.S. Cl. 280/730.2

(57) ABSTRACT

An airbag apparatus for suppressing the movement of an occupant body toward the vehicle outside. Upon a side-on collision or sideway rolling of an automobile, an inflator is operated so as to inflate an airbag by supplying gas into the airbag. The airbag pushes a cover member open so as to extend downward along a side of the vehicle compartment like a curtain and to inflate between vehicle occupants and a side of the vehicle compartment.

### BACKGROUND

The present invention relates to airbags for protecting the head of a vehicle occupant, and more in detail, it relates to an airbag to be inflated along a side door window.

As an airbag for protecting the head of an automobile occupant, there exists a curtain airbag that is arranged in the vicinity of the boundary corner between a ceiling and a side panel of an automobile compartment so as to inflate along a window of a side door by gas induced from a gas inlet.

When an automobile having the curtain airbag apparatus is collided side-on or rolls sideways, the curtain airbag inflates toward the vehicle bottom along the side of the vehicle compartment (a door and a pillar, for example) so as to protect the head of an occupant while preventing the occupant from being thrown out of the vehicle when the door is open.

A type of curtain airbag apparatus is disclosed in U.S. Pat. No. 6,237,938 (incorporated by reference herein). The patent discloses a curtain airbag inflating along the compartment panel. The disclosed airbag apparatus includes a guide member along the rear edge of the airbag. In order to prevent the rear end of the curtain airbag moved downward from returning upward, the curtain airbag is provided with latches arranged along the substantially entire length of the track at equal intervals.

Japanese Unexamined Patent Application Publication No. 2003-81048 (incorporated by reference herein) discloses a head-protecting airbag apparatus in that the rear of an inflated head-protecting airbag is pulled backward so as to generate a strong tension along the lower boundary of the head-protecting airbag.

### SUMMARY OF THE INVENTION

According to an embodiment of the present invention, the movement of an occupant body toward the outside of a vehicle can be suppressed by generating a tension along the lower boundary of the airbag.

A head-protecting airbag according to the present invention is capable of inflating along a side surface of a vehicle compartment, and includes tension-applying mechanism for applying a tension to the inflated airbag along a lower boundary of the airbag, wherein when the airbag is inflated. According to an embodiment of the present invention, the airbag has a vertical width so as to have a lower-border height of 82.5 mm or less from a beltline.

A head-protecting airbag apparatus according to the present invention includes the head-protecting airbag according to the present invention and an inflator for inflating the head-protecting airbag.

According to an embodiment of the present invention, the tension-applying mechanism may include a linear member extending along a lower boundary of the inflated head-protecting airbag and a means for applying a tension to the linear member, and when the head-protecting airbag is inflated, the linear member may preferably be positioned at a height of 82.5 mm or less above from the beltline of the vehicle.

In the head-protecting airbag, the airbag apparatus, and the vehicle according to the present invention, when the head-protecting airbag is inflated, its lower boundary is positioned directly above (less than 82.5 mm) the beltline (the lower edge of the side window, i.e., the upper edge of the door panel), and a tension is applied to the lower boundary of the airbag as well. In such a manner, by reducing the space between the lower boundary of the inflated head-protecting airbag and the beltline to a value of less than half of the diameter (165 mm) of the spherical head of a dummy doll for a bump test, the movement of the occupant body, the head in particular, toward the vehicle outside, is sufficiently suppressed.

Especially when the linear member for applying a tension to the airbag is positioned within 82.5 mm above the beltline during the inflation of the airbag, the movement of the occupant body toward the vehicle is further sufficiently suppressed.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a side view of an inside of a vehicle compartment having an airbag according to an embodiment, FIG. 1(a) showing a state of the airbag before inflation and FIG. 1(b) showing an inflated state of the airbag.

FIG. 2 is a sectional perspective view of the rear of the inflated airbag.

FIG. 3 is a sectional view at the line III-III of FIG. 2.

FIG. 4 is a structural drawing of a one-way pulley.

FIG. 5 is a sectional perspective view of the rear of an airbag according to another embodiment.

FIGS. 6(a) and 6(b) are a side views of the inside of a vehicle compartment having an airbag apparatus according to still another embodiment FIG. 6(a) shows a state that the airbag apparatus is mounted on a vehicle body 10′ of a type with a small overhang, such a mini-van; and FIG. 6(b) shows the inflated state of the airbag.

FIGS. 7(a) and 7(b) are perspective views of an airbag apparatus having such a guide member so as to generate a tension in the lower boundary of the head-protecting airbag; FIG. 7(a) shows a folded state of the airbag; and FIG. 7(b) shows a state that the inflation of the airbag is completed.

### DETAILED DESCRIPTION

This head-protecting airbag (may be simply called as an airbag) 1 is provided along a roof side, for example, between an A-pillar and a C-pillar of an automobile in a folded state, and when the vehicle is side-on collided or rolls sideways, the airbag is inflated and deployed along a side of vehicle compartment like a curtain so as to receive heads of occupants sitting on front and rear seats of the automobile cabin, preventing the heads from striking on the cabin side or being thrown out of a window.

The airbag 1 is formed by overlapping two sheets 2 and 3 being substantially identical in shape and making up two surfaces facing the compartment side and the inside the compartment, respectively, so as to combine the peripheral edges of the sheets 2 and 3 together with a linear seam 4. Although not shown, the airbag may also be divided into a plurality of small chambers by stitching the sheets 2 and 3 together so that the bag inside is further divided into several divisions or by providing panels for parting the bag inside.

A duct 5 is extended from the rear of the airbag 1 for inducing gas. To the duct 5, an inflator 6 is connected for inflating the airbag 1.

A plurality of projection pieces (selvages) 7 extend from upper and front borders of the airbag 1, each projection piece 7 having a bolt insertion-hole 7a for fastening the airbag 1 to a vehicle body. The airbag 1 is fastened to a roof side-rail 11 and an A-pillar 12 with the projection pieces 7 in a slenderly folded state so as to extend in a longitudinal direction of the vehicle body. Reference numeral 14 denotes a B-pillar.

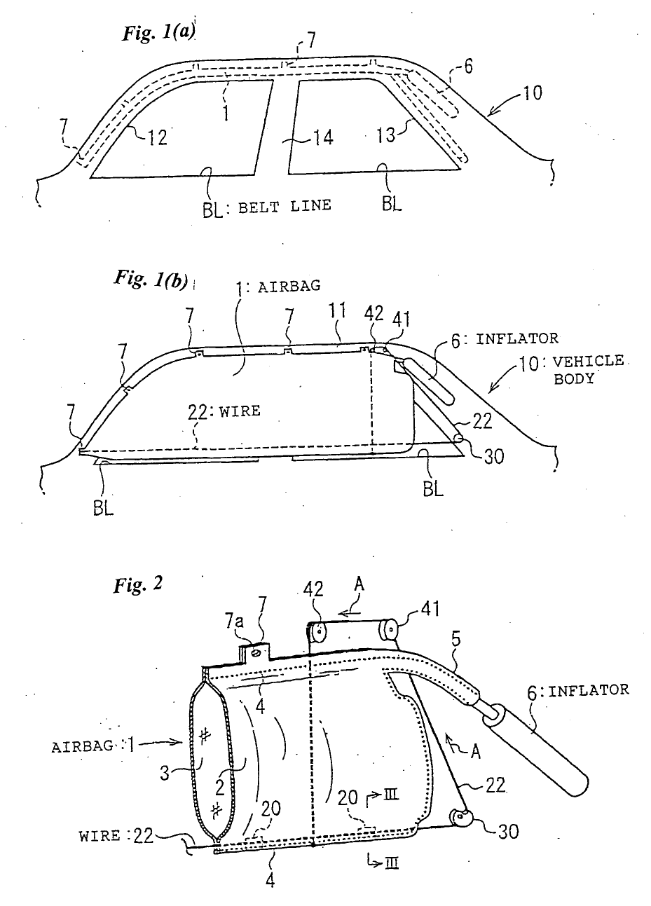

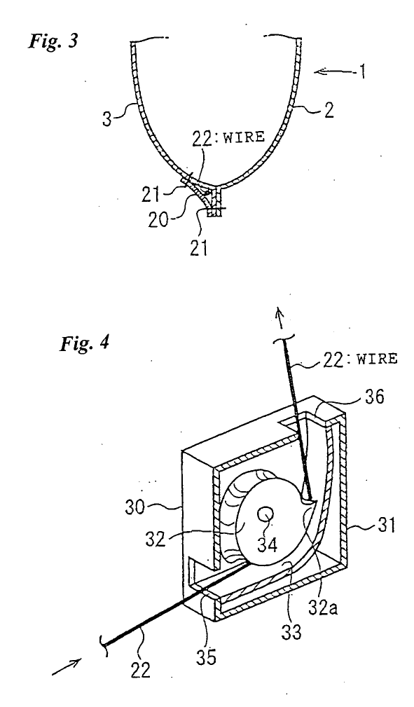

The folded body of the airbag 1 arranged in such a manner is covered with a cover member, such as a pillar trim and a roof trim, which is adapted to be forced open by the inflating airbag 1 so as to allow the airbag 1 to be deployed into the vehicle compartment. In FIG. 1b), the cover member is not shown for brevity.

The airbag 1 is provided with wire holders 20 arranged along the lower edge at predetermined intervals. The wire holder 20 is made of a small cloth piece with the upper and lower sides respectively sewn on the airbag 1 with sewing threads 21. Between the respective wire holders 20 and the airbag 1, a wire (a wire rope woven with synthetic fiber according to the embodiment) 22 is inserted through. The front end of the wire 22 is stuck to the lower front extremity of the airbag 1 by sewing, and is further fixed to the A-pillar 12 with fastening members such as bolts together with the projection piece 7 at the lower front extremity.

The rear end of the wire 22 extended from the lower rear extremity of the airbag 1 is stretched around a one-way pulley 30, and then routed upward along the C-pillar 13. A roof-side rail 11 is provided with pulleys 41 and 42 respectively attached to a rear portion and a portion slightly forward than the former. The wire 22 is stretched around the rear pulley 41 so as to proceed forward, and then stretched around the front pulley 42 so as to proceed downward. The wire 22 is routed to the lower end of the airbag 1 passing through the airbag 1 adjacent to a vehicle door, so that its end is stuck to the lower end of the airbag 1 such as by sewing and the like.

The one-way pulley 30, as shown in FIG. 4, includes a thin box-like case 31, a pulley body 32 arranged inside the case 31, and a guide surface 33 extending in an arch shape along the external periphery of the pulley body 32. The pulley body 32 is rotatably supported to the case 31 with a shaft 34 therebetween. The shaft 34 is eccentric relative to the pulley body 32. The pulley body 32 is provided with an arch-shape bulged portion 32a formed farther from the shaft 34 so as to face the guide surface 33.

Passage holes 35 and 36 for the wire 22 are formed on the front and upper surfaces of the case 31, respectively. The point in the arch-shape bulged portion 32a positioned farthest from the shaft 34 is located adjacent to the passage hole 36. Hence, when the wire 22 moves from the passage hole 35 toward the passage hole 36 as shown in Arrow of FIG. 4, the arch-shape bulged portion 32a moves toward the passage hole 36 accompanied by the wire 22, and the space between the pulley body 32 and the guide surface 33 increases so that the wire 22 passes through the one-way pulley 30 freely. On the other hand, when the wire 22 is to move in a direction opposite to the arrow direction of FIG. 4, the arch-shape bulged portion 32a is to move toward the passage hole 35 accompanied by the wire 22, so that the wire 22 is pinched between the arch-shape bulged portion 32a and the guide surface 33, resulting in stopping of the wire 22.

The operation of a head-protecting airbag apparatus having the airbag 1 structured in such a manner will be described.

Upon a side-on collision or sideway rolling of an automobile, the inflator 6 is operated so as to inflate the airbag 1 by supplying gas into the airbag 1. The airbag 1 pushes the cover member open so as to extend downward along a side of the vehicle compartment like a curtain and to inflate between vehicle occupants and the side of the vehicle compartment. Owing to the inflated airbag 1, the vehicle occupants are prevented from directly string pillars and window glass or being thrown out of the vehicle.

When the head-protecting airbag is inflated to downward deploy, the rear end of the wire 22 is pulled to move in the arrow A direction of FIG. 2, so that the wire 22 becomes strongly tense along the lower boundary of the airbag 1. According to the embodiment, the wire 22 in a strongly tense state is positioned within 82.5 mm above a beltline BL, preferably within 80 mm, and more preferably within 70 mm in particular. In such a manner, the lower boundary of the airbag 1 descends just above the belt line BL so as to have a strong tension applied by the wire 22, so that the movement of vehicle occupants toward the vehicle outside is sufficiently suppressed. Since the one-way pulley 30 is adopted especially according to the embodiment, the slack of the wire 22 along the lower boundary of the airbag 1 is removed, so that the movement of vehicle occupants toward the vehicle outside is sufficiently suppressed for a long time.

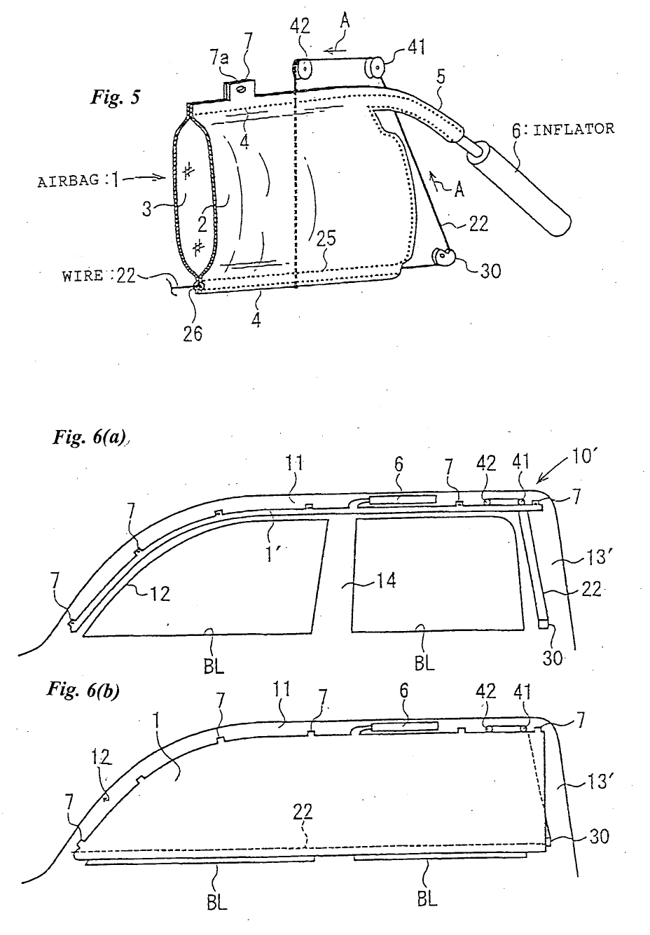

According to the embodiment, a plurality of the wire holders 20, each made of a small cloth piece, are attached in the bottom of the airbag 1. As shown in FIG. 5, the airbag 1 is provided with a seam 25 formed in parallel to the seam 4 formed along the lower edge of the airbag 1 so as to form a tunnel wire path 21 between the seam 4 and 25. The wire 22 may also be inserted through the wire path 21.

According to the embodiment, a vehicle body 10 is a sedan type; alternatively, other types may incorporate the present invention. FIG. 6(a) shows a state that the airbag apparatus is mounted on a vehicle body 10′ of a type with a small overhang, such a mini-van; and FIG. 6(b) shows the inflated state of the airbag 1′. According to this embodiment, since a space for arranging the inflator is small in a C-pillar 13′, the inflator 6 is arranged in the roof side-rail 11. Other structures in FIG. 6 are the same as in FIG. 1, and like reference characters designate like elements. The airbag 1′ also has a strong tension applied by the wire 22 along the lower boundary when inflated, while the wire 22 is adapted to be positioned within 82.5 mm above the beltline BL, so that the movement of vehicle occupants toward the vehicle outside is sufficiently suppressed.

As described above, according to an embodiment of the present invention 82.5 mm is specified as a preferential distance for positioning the wire above the beltline of the vehicle. However, the scope of the present invention is not limited to the 82.5 mm distance. For example, according to various embodiments of the present invention, the wire may be positioned at any suitable height between 82.5 mm above the beltline and the beltline including, for example, approximately 60 mm, 45 mm, 30 mm, or 15 mm.

Any of the embodiments described above is an example of the present invention, and structures other than ones shown in the drawings may incorporate the invention. For example, the wire 22 may be adapted to have a tension along the lower boundary of the airbag by pulling the lower rear end (or front end) of the airbag.

Also, according to the present invention, a guide member may be provided for guiding longitudinal ends of a curtain airbag downward deploying along the side of a vehicle compartment so as to generate a tension along the lower boundary of the airbag by the guide member. In this case, the guide member nay be provided with an anchor portion formed by bending or curving the lower portion of the guide member so as to stop the ends of the curtain airbag descending along the guide member from returning upward. Forming the anchor portion by bending or curving the guide member in such a manner is made by very simple and relatively cost effective process in comparison with conventional methods such as disclosed in the aforementioned patent.

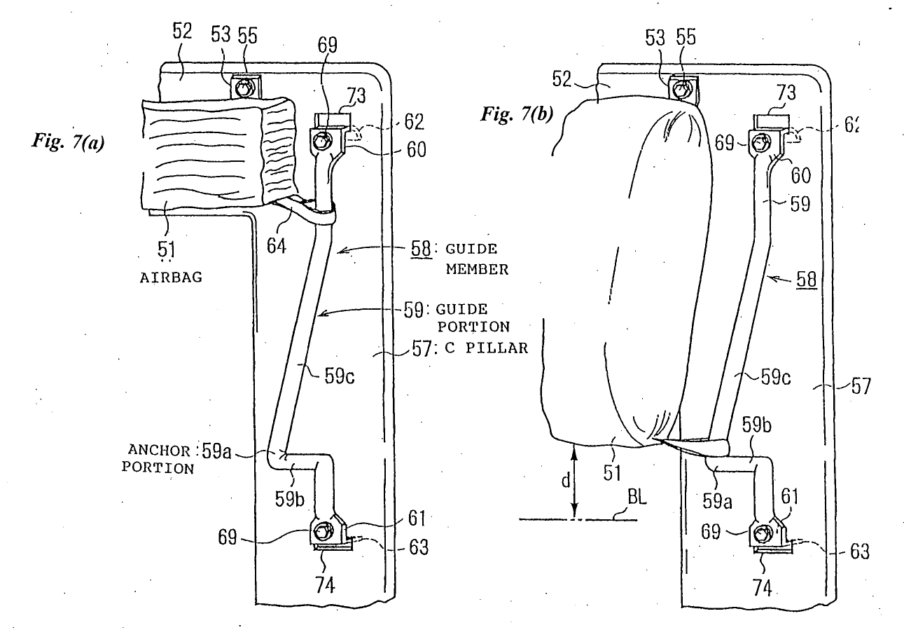

FIG. 7 is a perspective view of an airbag apparatus having such a guide member so as to generate a tension in the lower boundary of the head-protecting airbag; FIG. 7(a) shows a folded state of the airbag; and FIG. 7(b) shows a state that the inflation of the airbag is completed.

According to this embodiment, a head-protecting airbag 51 is arranged along a roof side portion of a vehicle (boundary between a ceiling and a side of a vehicle compartment) 52 in a slenderly folded state in a longitudinal direction. When an automobile is collided side-on or rolls sideways, the airbag 51 starts inflating by gas from the inflator so as to inflate and deploy toward the bottom of the vehicle body along the side of the vehicle compartment, such as doors and pillars. The airbag 51 is provided with selvages 53 formed in the upper border. By inserting bolts 55 into bolt-insertion holes of the selvages 53 so as to be screwed into tapped holes of the roof side portion 52, the airbag 51 is anchored to the roof side portion 52.

To a C-pillar 57 of an automobile, a guide member 58 is attached for guiding the rear end of the airbag 51 along the C-pillar 57 when the airbag 51 is inflated along the C-pillar 57 toward the bottom of the vehicle body. The guide member 58 includes a rod-like guide portion 59 extending along the C-pillar 57 in the vertical direction of the vehicle body, upper and lower fixing parts 60 and 61 for respectively fixing upper and lower ends of the guide portion 59 to the C-pillar 57, and temporary anchor portions 62 and 63 for temporarily anchoring the upper and lower fixing parts 60 and 61 to temporary openings 73 and 74 of the C-pillar 57, respectively, when the guide member 58 is attached to the C-pillar 57.

The airbag 51 is provided with a loop connection band 64 attached to the vicinity of the lower rear end corner, and the rear end is connected to the guide member 58 by inserting the guide portion 59 into the connection band 64.

The guide portion 59 is made of a pipe-like member. The lower part of the guide portion 59 is bent in a substantial crank-shape so as to form an anchor portion 59a made of an L-shaped corner protruding toward the airbag 51 for the connection band 64. A substantial horizontal portion 59b linking with the anchor portion 59a functions as a stopper for stopping the connection band 64 from moving to a position lower than the anchor portion 59a.

The guide member 58 is fixed to the C-pillar 57 by inserting bolts 69 into bolt insertion holes provided in the fixing parts 60 and 61 so as to be screwed into tapped holes formed in the C-pillar 57, respectively.

In the airbag apparatus shown in FIG. 7 and structured in such a manner, when the airbag 51 starts inflating by the operation of the inflator, while being guided by the guide member 58 with the connection band 64 therebetween, the airbag S1 is deployed toward the bottom so as to complete the inflation as shown in FIG. 7(b).

According to the embodiment, the guide member 58 is arranged so that the higher a portion 59c upper than the anchor portion 59a is, the more it is located rearward the vehicle. Hence, when the airbag 51 is completed to inflate, the connection band 64, which is the rear end of the airbag 51, is prevented from upward returning. That is, when the airbag 51 is inflated, the length in the longitudinal direction is reduced by a tension applied to the external surface so that the rear end is pulled forward. In the completed step of the inflation shown in FIG. 7(b), the connection band 64 cannot move upward and rearward along the guide portion 59 so as to remain at the anchor portion 59a, thereby generating a strong tension along the lower boundary of the airbag 51.

Also, according to the embodiment, in a completed state of inflation of the airbag 51, a space d between the lower boundary of the airbag 51 and the beltline BL (FIG. 7(b)) is 82.5 mm or less Thereby, the movement of the head of an occupant toward the vehicle outside is sufficiently suppressed.

As described above, according to an embodiment of the present invention 82.5 mm is specified as a preferential distance for positioning the bottom of the inflated airbag above the beltline of the vehicle. However, the scope of the present invention is not limited to the 82.5 mm distance. For example, according to various embodiments of the present invention, the bottom of the inflated airbag may be positioned at any suitable height between 82.5 mm above the beltline and the beltline including, for example, approximately 60 mm, 45 mm, 30 mm, or 15 mm.

The priority application, Japanese Patent Application No-2003-403197 filed Dec. 2, 2003, is hereby incorporated by reference herein in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

1. A head-protecting airbag capable of inflating along a side surface of a vehicle compartment comprising: a mechanism for applying a tension to the inflated airbag along a lower boundary of the airbag and wherein the airbag is configured so that when the airbag is inflated a lower boundary of the airbag is 82.5 mm or less from a beltline of the vehicle.

2. The airbag of claim 1, wherein the airbag is adapted to be operatively connected to a linear member configured to extend along a lower boundary of the inflated airbag; and wherein a mechanism applies a tension to the linear member.

3. The airbag of claim 2, wherein the airbag is configured so that when the airbag is inflated the linear member is positioned at a height of 82.5 mm or less above from the beltline of the vehicle.

4. An airbag apparatus for a vehicle comprising:
an airbag configured to deploy along a side of a vehicle compartment between the head of the occupant and a side of the vehicle;
an inflator for supplying inflation gas to the airbag; and
a tensioning device positioned in a lower boundary of the airbag for tensioning the airbag when the airbag is inflated.

5. The apparatus of claim 4, wherein the device includes a wire connected to a lower boundary of the airbag.

6. The apparatus of claim 5, wherein the wire extends through a one-way pulley configured to be mounted to the vehicle frame.

7. The apparatus of claim 5, wherein the apparatus is configured so that when the airbag is inflated the wire is positioned less than about 82.5 mm above a beltline of the vehicle.

8. The apparatus of claim 4, wherein the device includes a band connected to a substantially vertically aligned guide member configured to be mounted to the vehicle frame.

9. The apparatus of claim 8, wherein the band is configured to slide downward along guide member when the airbag is inflated, and wherein the guide member includes an anchor portion configured to prevent the guide member from moving upward along the guide member after the airbag is inflated.

10. The apparatus of claim 9, wherein the anchor portion is positioned so that the lower boundary of the airbag is less than about 82.5 mm above a beltline of the vehicle.

11. A vehicle comprising an airbag apparatus including an inflator and an airbag configured to inflate along a side surface of a vehicle compartment and further including a mechanism for applying a tension to the inflated airbag along a lower boundary of the airbag and wherein the airbag is configured so that when the airbag is inflated a lower-boundary of the airbag is 82.5 mm or less from a beltline of the vehicle.

12. The vehicle of claim 11, further comprising a linear member configured to extend along a lower boundary of the inflated head-protecting airbag; and a mechanism for applying a tension to the linear member.

13. The vehicle of claim 12, wherein the airbag is configured so that when the airbag is inflated the linear member is positioned at a height of 82.5 mm or less above from the beltline of the vehicle.
